(19) United States
(12) Patent Application Publication
(10) Pub. No.: US 2009/0319337 A1
(43) Pub. Date: Dec. 24, 2009

(54) Optical product network via Internet

(76) Inventor: Yiling Xie, Wenzhou City (CN)

Correspondence Address: DAVID AND RAYMOND PATENT FIRM, 108 N. YNEZ AVE., SUITE 128, MONTEREY PARK, CA, 91754, US

(21) Appl. No.: 12/455,833

(22) Filed: Jun. 8, 2009

Related U.S. Application Data
(60) Provisional application No. 61/131,595, filed on Jun. 9, 2008.

(51) Int. Cl. G06Q 30/00; G06Q 50/00; G06Q 10/00

(52) U.S. Cl. 705/10; 705/26; 705/27

(57) ABSTRACT

An optical product network includes a plurality of product provider stations for a plurality of wholesalers and/or manufacturers jointing therewith, a plurality of sale stations for a plurality of retailers and/or exclusive venders joining therewith, and a management system forming a network bridge to link the product provider stations with the sale stations via Internet, wherein the management system manages a purchasing order from each of the sale stations for requesting an optical product from at least one of the wholesalers in a quantity manner, such that the management system is adapted for effectively managing the optical products to maximize a mutual benefit and collaboration between the wholesalers and the retailers in a quality and quantity manner.

### CROSS REFERENCE OF RELATED APPLICATION

This is a non-provisional application of a provisional application, having an application No. 61/131,595 and a filing date of Jun. 9, 2008.

### BACKGROUND OF THE PRESENT INVENTION

1. Field of Invention

The present invention relates to optical products, and more particularly to an optical product network linking a plurality of optical product providers with a plurality of optical product retailers via internet for marketing and managing the optical products to maximize the mutual benefit and collaboration in a quality and quantity manner and simplifying the order management between the optical product providers and the optical product retailers.

2. Description of Related Arts

In recent years, the global computer network, World Wide Web or the Internet plays a very important role in the worldwide economy. The Internet affects not only the development of the modern computer and communicating technologies, but also the development of doing the buying and selling business in other means rather than the traditional retailing channels. Especially, the Internet affects the traditional marketplaces that bring buyers and suppliers together.

For example, the traditional retailing channel for the optical products includes a first level between the manufactures and the wholesalers, a second level between the wholesalers and the retailers, and a third level between the retailers and the consumers. In other words, the optical products are indirectly sold to the consumers from the manufacturers through the wholesalers and the retailers, resulting that the end selling price of a optical product to the consumer has been marked up hundred times from the manufacturing cost of the optical product of the manufacturer.

Accordingly, the wholesalers, which can also be the manufacturers, would like to sell the optical products to the retailers in large quantity. Since the wholesalers generally supply the optical products to the retailers locally, the wholesalers are unable to vend the optical products at volumes to the retailers. In other words, the wholesalers must sell the optical products in a predetermined quantity to lower the wholesale price thereof. Therefore, the retailers must mark up the retailer price to compensate the higher wholesale price and the shipping cost thereof.

Since a retailer may only contact with several wholesalers locally, the order of the optical products will be extremely limited. Thus, the retailer would like to order the optical products from the wholesalers in small quantity. The retailers do not keep a large stock of the optical products by ordering the optical products because the cost for stocking the optical products is relatively expensive. However, every consumer would like to try all favor optical products of different styles or brands so as to ensure which fits his or her need the most before his or her purchases. Although there are thousands of new optical products in the market, each retailer may only provide a very limited number of selected optical products in stock. The consumer may miss the chance of trying some other optical products before making decision. On the other hands, a retailer may lose a potential customer simply because it fails to carry a particular optical product that the customer likes.

Furthermore, the consumers will have no other choice to purchase the optical products at a higher retail price from the retailers and have fewer choices of the optical products to be selected. As a result, there is no mutual benefit and collaboration among the optical product providers such as manufacturers and wholesalers, the retailers, and the consumers.

As an optical product manufacturer, especially an OEM or ODM manufacturer, for security purpose, it has to manufacture an excess number of the ordered optical products. For example if the order is 1500 pairs of spectacle, it will generally make about 50 pairs more as security stock in case something wrong to the product shipped to the buyer. These will become leftover after the deal and can sell to nobody. On the other hand, it is so difficult for an OEM manufacturer to develop its own brand name because of the lacking of retailing and marketing capability.

To the wholesalers or the retailers, although they may all purchase the same styles of optical product from the same manufacturer, they all have to produce visual images (such as pictures), pricing and stocking information for their websites, catalogues and management system by their own. There is no connection in such information with each other.

### SUMMARY OF THE PRESENT INVENTION

An object of the present invention is to provide a wearable personal product network, especially for an optical product network, linking a plurality of optical product providers, such as manufacturers and wholesalers, with a plurality of optical product retailers and/or exclusive venders for not only managing the optical products to maximize the mutual benefit and collaboration in a quality and quantity manner but also simplifying the order management between the optical product providers and the optical product retailers.

Another object of the present invention is to provide an optical product network, wherein the purchasing orders from the retailers and/or exclusive venders are consolidated by a management system for the respective product provider to ensure the quantity of the optical product to be vended and to lower the price of the optical product being purchased by the retailers.

Another object of the present invention is to provide an optical product network, wherein the consumers plays an important role in the optical product network that the retailers and/or exclusive venders are able to order the optical products from the product providers according to the consumers' favors so as to enhance the successful selling preparation of the optical products.

Another object of the present invention is to provide an optical product network, through which the manufacturers may promote and market their optical products with their own brand names or trademarks.

Another object of the present invention is to provide an optical product network, through which the product providers such as manufacturers and wholesalers may sell out their leftover products.

Another object of the present invention is to provide an optical product network, linking the product providers with the retailers and/or exclusive venders, wherein product information such as visual images, pricing, product specification, and stocking information can be saved in a product database by the corresponding product provider, so that the retailers and/or the exclusive venders can directly download the product information from the product database and modify into their own websites.

Another object of the present invention is to provide a method of networking the optical product between product providers and retailers and/or exclusive venders, wherein the method involves a combination of the Business to Business (B2B) method between the product providers and the retailers and/or exclusive venders through the management system, and Business to Consumer (B2C) method between the retailers and/or exclusive venders and the consumers through the management system, so as to benefit all the manufacturers, the wholesalers, the retailers, the exclusive venders, and the consumers for global business solution.

Another object of the present invention is to provide a method of networking the optical product between product providers, such as manufacturers and wholesalers, and retailers and/or exclusive venders, wherein the consumer is able to self-design the optical product, especially for the spectacles, such that the product providers are able to tailor-make the optical product for the consumer so as to keep in touch with the latest trends of fashion from the consumer and to the minimize the designer cost of designing the optical product.

Another object of the present invention is to provide a method of networking the optical product between product providers, such as manufacturers and wholesalers, and retailers and/or exclusive venders, wherein the product providers and the retailers and/or exclusive venders, especially for small size businesses, can still be developed in the epoch of globalization, so as to minimize the impact of the globalization.

Another object of the present invention is to provide a method of networking the optical product between product providers, such as manufacturers and wholesalers, and retailers and/or exclusive venders, which is adapted to not only evaluate the cost efficiency and exact acceptable prices for the optical products but also to activate and speed up the optical product developments and consumption by expressing the consumers' needs with new designs.

An object of the present invention is to provide an optical product network, wherein the network provides a system and method of producing test-wearing image for personal products, wherein a test-wearing image containing a virtual appearance of the wearer wearing the personal product is generated to simulate the actual wearing image for the wearer.

Another object of the present invention is to provide an optical product network, wherein two or more product images can be concurrently posted on the posting platform to overlap with the base image layer. Therefore, the test-wearing image contains a virtual appearance of the wearer physically wearing two or more different personal products at the same time.

Another object of the present invention is to provide an optical product network, which provides a simple and precise frame calibrating operation to calibrate a frame scale of the image of the personal product with respect to the image of the wearer.

Another object of the present invention is to provide an optical product network, wherein the wearer is able to shop the personal products through a public communication network, such that the wearer is able to customize the personal products through the public communication network to selectively match the image with the personal products without actually wearing on the personal products.

Another object of the present invention is to provide an optical product network, wherein the wearer is able to optimize the personal products through the public communication network to selectively match his/her image with the personal products in a rapid and accurate manner.

Another object of the present invention is to provide an optical product network, wherein the wearer is able to update the image anytime by using a digital camera, a web cam, scanning a photo, and etc., such that the wearer is able to shop the personal products anytime by a click of a mouse.

Another object of the present invention is to provide an optical product network, wherein the system will only require two different layers, i.e. the base image layer and the product image layer, to post on the posting platform such that the system will save lots of memory space. In particularly, the product database requires less memory space to store one single personal product in different images.

Another object of the present invention is to provide an optical product network, wherein when the wearer provides a color image, the color of the personal product can be selected to match with the skin color of the user once the shape and size of the personal produce is selected. Therefore, the test-wearing image is shown as a mirror image to show how the wearer would appear while wearing the personal product with the selected shape, size, and color.

Another object of the present invention is to provide an optical product network, wherein an image effect is applied to the image of the personal product to enhance the test-wearing image of the virtual appearance of the wearer wearing the personal product. The image effect includes a fade out effect to gradually diminish the image of the personal product from the display area to the masking area of the base image layer, a light reflective effect to generate a light reflection of the image of the personal product, a shading effect to simulate a shading of the personal product on the image of the wearer, and a color blending effect to blend a color of the image of the personal product with a color of the image of the wearer.

Another object of the present invention is to provide an optical product network, wherein the system can calibrate the image in different angles, such as a three quarter face position, to match the frame scale of the personal product with the image of the wearer so as to provide alternative view of the appearance.

Another object of the present invention is to provide an economic and efficient solution for providing a method and system for the wearer to test-wear the personal products through the public communication network or computer.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of an optical product network according to a preferred embodiment of the present invention, illustrating a relationship among the product providers, the retailers and/or exclusive venders, and the consumers through the optical product network.

FIG. 2 is a flow diagram illustrating the method of networking the product providers, the retailers and/or exclusive venders, and the consumers through the optical product network according to the above preferred embodiment of the present invention.

FIG. 3 is a flow diagram illustrating a test-wearing image producing method for a personal product according to the above preferred embodiment of the present invention.

FIG. 4 is a block diagram illustrating the test-wearing image producing system for a personal product according to the above preferred embodiment of the present invention.

FIG. 5 is a flow diagram illustrating a calibrating process a frame scale of the spectacle image with respect to the facial image according to the above preferred embodiment of the present invention.

FIG. 6A illustrates an interface of the production system according to the above preferred embodiment of the present invention.

FIGS. 6B and 6C illustrate a base image layer of the production system according to the above preferred embodiment of the present invention.

FIG. 7 illustrates a product image layer of the production system according to the above preferred embodiment of the present invention.

FIGS. 8A and 8B illustrate a test-wearing image of the production system according to the above preferred embodiment of the present invention.

FIGS. 8C and 8D illustrate the product image layer locating on the base image layer in an adjustably movable manner.

FIG. 9 illustrates a reference image layer of the production system according to the above preferred embodiment of the present invention.

FIGS. 10A and 10B illustrate the test-wearing image of the production system according to the above preferred embodiment of the present invention, wherein the three quarter face position is shown on the base image layer.

FIGS. 11A and 11B illustrate the test-wearing image of the production system according to the above preferred embodiment of the present invention, wherein the side face position is shown on the base image layer.

### DETAILED DESCRIPTION OF THE PREFERRED EMBODIMENT

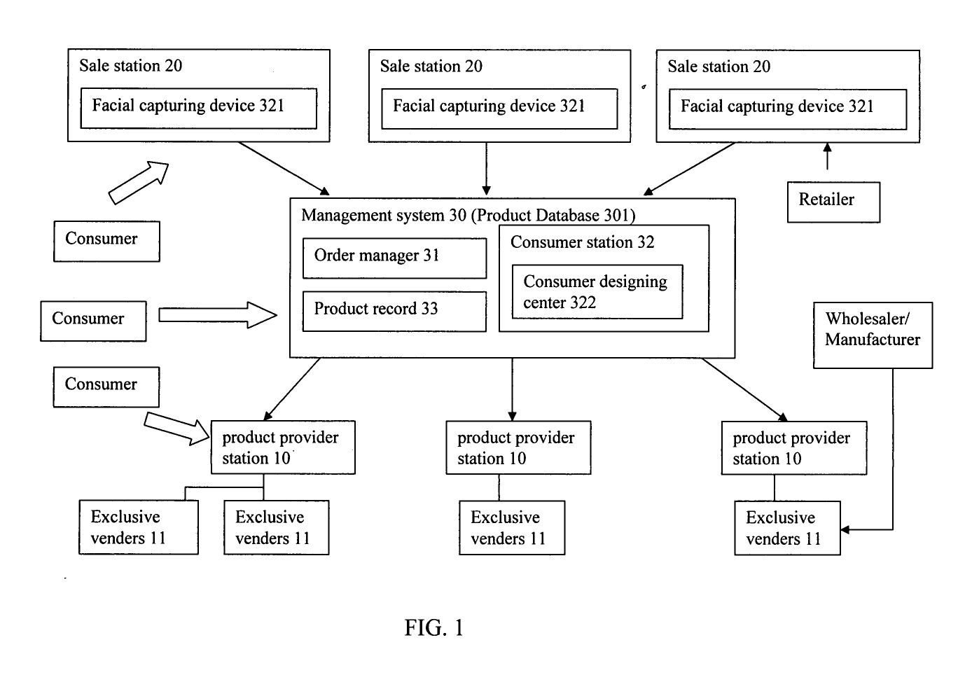

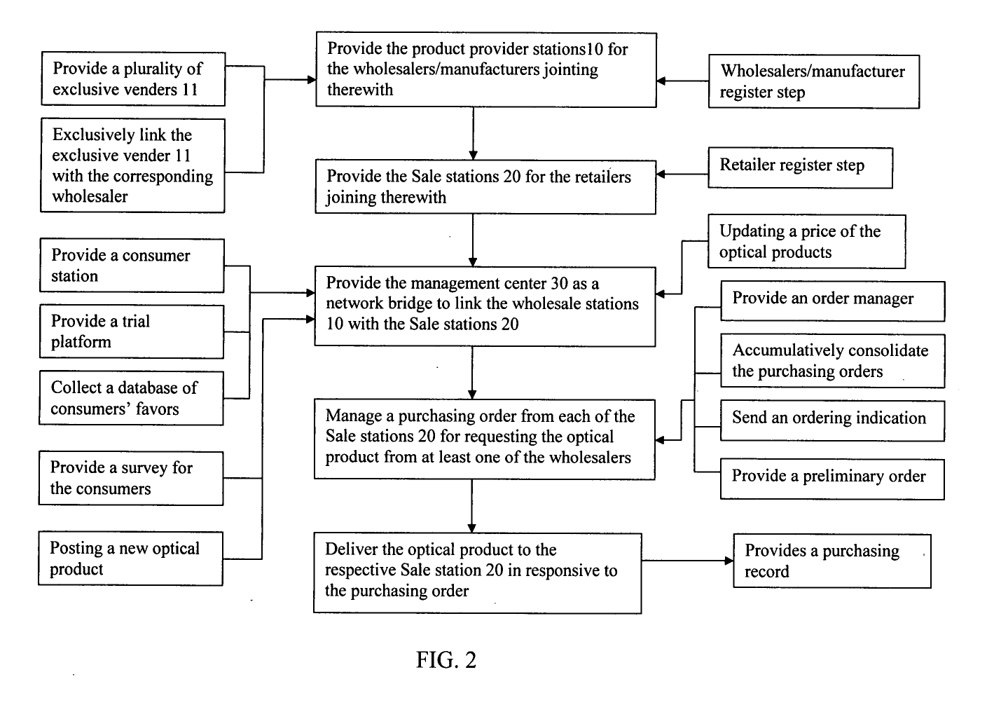

Referring to FIGS. 1 and 2, a wearable personal product network and a method thereof according to a preferred embodiment of the present invention is illustrated, wherein the product network is an internet network comprising a plurality of product provider stations 10, a plurality of sale stations 20, and a management system 30. According to the preferred embodiment of the present invention, the system can be embodied as a server operated by a management entity and the stations can be embodied as websites that the consumers can login through the Internet to conduct online shopping and purchasing, wherein the websites can be operated and managed by the management entity or the retailer and/or exclusive vender entities.

As shown in FIG. 2, the product providers such as manufacturers and wholesalers of one or more wearable products are networked with sale entities such as retailers and exclusive venders, wherein each of the product providers is provided with a product provider station 10 and each of the retailers and/or exclusive venders (sale entities) is provided with a sale station 20. The product provider stations 10 and the sale stations 20 are registered in the management system 30 which is a network bridge linking the product provider stations 10 with the sale stations 20 via Internet. Preferably, optical products are used as an example to illustrate the network of the present invention.

When a purchasing order from each of the sale stations 20 for requesting the one or more optical products from at least one of the product providers is placed with the management system 30, the optical products are delivered to the respective sale entity of the sale station 20 in responsive to the purchasing order, such that the management system 30 is adapted for effectively managing the optical products to maximize a mutual benefit and collaboration between the product providers and the sale entities in a quality and quantity manner.

According to the present invention, the personal product includes a watch, an ear ring, a necklace, and etc. that the personal product can be worn by the wearer. In particularly, as the example, the optical product can be an optical lens, a spectacle frame, a contact lens, spectacle components including temples or bridges, and auxiliary lens frame.

The manufacturers and/or wholesalers of the product providers and the retailers and/or exclusive venders of the sale entities may be located at different cities, different states, or different countries and are communicatively linked through the management system 30. In other words, for example, a sale entity in the United States is able to make the purchasing order to a wholesaler in China via the management system 30.

According to the preferred embodiment, the product providers and the sale entities should register their product provider stations 10 and the sale stations 20 respectively with the management system 30. Once the manufacturers, the wholesalers, the retailers, and the exclusive venders become the members of the network, they are able to access the management system 30 via Internet. It is worth to mention that the wholesalers can also be the manufacturers for manufacturing the optical products.

Each of the product providers and the sale entities can be registered by logging in the management system 30 through Internet, in which a predetermined amount of membership fee may be requested to pay in order to register as a member of the management system. After the registration, a member ID is assigned for each of the registered product providers and the sale entities.

As mentioned above, the management system 30, which is functioned as an electronic service center, can be controlled and operated by an association, an organization, or a Central Processing Center who consolidates the purchasing order in running and managing the network of the present invention. It is worth to mention that when each of the sale entities requests a small quantity of any of the optical products, the management system 30 consolidates the purchasing order not only for maximizing the quantity of the optical product but also for maintaining the good quality of the optical product. Therefore, the product provider is able to ship the optical product with a predetermined quantity to the sale entities to maximize a mutual benefit and collaboration between the product providers and the sale entities in a quality and quantity manner.

The management system 30 provides a product database 301 for storing the information of the optical products from each of the product providers. The sale entity can access the product database to view all the optical products before a purchasing order is made. The information of each optical product includes price, model, size, dimension ratio, picture, and etc. . . .

The product information of each optical product such as visual images, pricing, product specification, and stocking information is saved in the product database 301 by the corresponding product provider, so that the retailers and/or the exclusive venders can directly download the product information from the product database and modify into their own websites. For example, once the visual images such as the display pictures of a spectacle product is saved through the product provider station 10 by the manufacturer in the product database 301 of the management system 30, the sale stations 20 of the retailers or exclusive venders can simply download such visual images of the spectacle products selected to carry to form their web pages for sale while inputting their own sales information such as item numbers, pricing, brand names and etc. It is so convenience for the retailers and/or exclusive venders to contribute and update their sale stations 20 while the conventional retailers have to take their own pictures of the products, arrange the products for sale and input product information by their own effort to make their website. It wastes a great deal of labor and cost.

The management system 30 may also provide sale station templates for retailers and/or exclusive venders to contribute their sale stations 20, wherein the sale station templates are compatible with all the software of the management system 30 including the product database 301 so that the retailers and/or exclusive venders can simply select the sale station templates they like and import the information of the optical products selected to carry for sale and input their specific sale information such as item numbers and pricing.

As shown in FIGS. 1 and 2, beside retailers, exclusive venders 11 are also provided as sale entities. The exclusive venders 11 are operated directly by the product providers such as manufacturers and wholesalers to sell optical products made by them with their own brand names. Generally, it is difficult for an OEM or ODM manufacturer to develop into an OBM manufacturer because of the lacking of sale channels. According to the optical product network of the present invention, the manufacturers or even the wholesalers can set up their websites as sale stations 20 of exclusive venders 11 for offering to sell their optical products including leftover products to the consumers directly. It is also a great channel for the product providers to sell their optical products with their own brand names or trademarks. In other words, the product provider stations 10 are operated by the product providers to sell optical products manufactured to the sale stations 20 of the retailers and the sale stations 20 of the exclusive venders 11 are also operated by the product providers to sell their own optical products to the consumers. The sale stations 20 of the exclusive venders 11 are exclusively linked with the corresponding product provider stations 10 to vend the optical products from the exclusive vender 11.

Also, the sale stations 20 of the exclusive venders 11 are established for exclusively linking with the respective product provider stations to vend said optical products therefrom. Each of the exclusive venders 11 can only carry the particular brand or model from the corresponding product provider. Since the product provider would like to take the purchasing order in responsive to a large quantity of optical products, the product provider is able to save a small amount of optical products for the exclusive vender 11 to build up the quantity of the optical products. In other words, the product provider is able to order the optical product in volume for distributing the optical product to different retailers and to the exclusive vender 11 at the same time so as to further lower the cost of the optical products. It is worth to mention that the exclusive vender 11 can be established as an outlet shop of the manufacturer or wholesaler such that the optical products returned from the retailers can be saved and shipped to the exclusive vender 11 of the product provider for sale.

According to the present invention, an order manager 31 is provided to link the product provider stations with the sale stations via Internet so as to accumulatively consolidate the purchasing orders from the sale stations 20 by the order manager 31. When the purchasing orders reach a predetermined quantity, an ordering indication is simultaneously sent from the order manager 31 to the respective product provider station 10 for contacting the corresponding wholesaler.

Accordingly, the management system 30 comprises the order manager 31 to link the product provider stations 10 with the sale stations 20 via Internet. The retailers can communicatively link to the order manager 31 through the sale station 20 in order to make the purchasing order for the optical product. Therefore, the order manager 31 will accumulate the purchasing orders from different retailers until the quantity of the optical product meets the minimum requirement of the wholesaler. Accordingly, the order manager will set a time period for the retailers to make the purchasing order such that the deal of the optical product will not be made once the time is expired. Thus, when the quantity of the optical product is large enough, the order manager 31 is adapted to negotiate with the wholesaler to further lower the price from the respective wholesaler. In other words, the management system 30 becomes a wholesale center to accumulatively collect the needs from different retailers and to inform the different wholesalers.

In addition, the management system 30 further updates the price of each of the optical products from the wholesalers to the retailers and/or the exclusive venders frequently. Since the price of each optical product may change from time to time such as every month, the management system 30 will update the information of the optical product to bring the relationship between the retailers/exclusive venders and the wholesalers closely.

The management system 30 further comprises a product record 33 recording each of the optical products being ordered at each of the sale stations 20. Accordingly, each retailer is able to check the purchasing order from other retailers through the product record 33 such that the retailers are able to determine whether the optical product is popular or not. In other words, the prices of the optical products will further be standardized to build up the relationship between the wholesalers and the retailers/exclusive venders.

In order to link the consumers with sale stations 20 of the retailers/exclusive venders and product provider stations of the wholesalers, according to the present invention, a consumer station is provided for the consumers communicatively accessing thereto via Internet and a trial platform is provided for the consumer trying the optical products through Internet. Therefore, a database of consumers' favors is collected for the retailers/exclusive venders to make the purchase order thereof.

According to the preferred embodiment, the management system 30 further comprises a consumer station 32 for the consumers communicatively accessing thereto via Internet, wherein the consumers are able to access the trial platform of the consumer station 32 to virtually try the optical products. Then, the management system 30 collects the database of consumers' favors as a reference for the retailers to make the purchase order thereof.

The consumer station 32 provides a feedback as a survey regarding interests and needs in different optical products for each of the consumers, wherein the survey will then be saved in the consumer station 32 as the database of consumers' favors such that the retailers/exclusive venders, as well as the wholesalers and manufacturers, are able to analyze and group the survey for making the purchasing order.

In addition, the consumer station 32 further comprises a new product forum for posting a new optical product thereon via Internet to let the consumers test-trying. Accordingly, the retailers/exclusive venders and/or the wholesalers/manufacturers are able to post the new optical product at the new product forum of the consumer station 32 for the consumers to test-try. Then the survey as the feedback can indicate the interest of the consumers on the new optical product. Having the feedback from the consumers regarding to the trial of the optical product and the new design thereof, the retailers/exclusive venders are able to make the purchasing order in responsive to the like and dislike of the optical product with respect to the consumers. Thus, the wholesalers are able to understand the needs of the consumers.

It is worth to mention that the optical product can be guaranteed to sell good for the consumers regarding to the survey of the consumers. Therefore, the retailers/exclusive venders do not have to guess the trend of the consumers' favor before making the purchasing order.

For test-trying the optical product via Internet, the consumer station 32 comprises a facial capturing device 321 which is provided at each of the sale stations 20 for the retailer capturing a facial image of the consumer and is linked to the trial platform via Internet for simulating a virtual appearance of the consumer with the optical product. The facial capturing device 321, which can be a camera station, is set up in each of the shops of the retailer and/or exclusive vender, wherein the facial capturing device 321 is adapted to capture a full frontal photo as the facial image of the consumer and calibrate a distance between the two pupils of the consumer. Having the shape of the face of the consumer and the distance between the pupils thereof, the consumer station 32 is linked to the product database 301 such that the image of the selected optical product can be overlapped on the facial image of the consumer to simulate the virtual appearance of the consumer test-trying the respective optical product.

For example, when the consumer wants to test-wear a spectacle frame, he or she can simply provide the facial image at the retailer's shop by the facial capturing device 321. Once the facial image is captured, the facial capturing device 321 will automatically evaluate the information of the consumer including the shape of the face of the consumer, the distance between the pupils of the consumer, the age of the consumer, and so on. Then, the consumer is able to select at least one of the spectacle frame images from the database. The facial capturing device 321 will automatically calibrate the frame scale with respect to the two pupils of the consumer to fittingly overlap the spectacle frame image on the facial image, so as to simulate the virtual appearance of the consumer wearing the respective spectacle frame. It is worth to mention that the spectacle frame images can be zoomed in and out to enlarge and shrink the ratio between the spectacle frame image and the facial image to fit the spectacle frame image on the facial image of the consumer. Therefore, the user is able to test wear thousands of spectacle frames without physically wearing on the optical products. Thus, the retailers do not have to hold thousands of different spectacle frames in stock for the consumers to try. Once, the particular optical product is selected by the consumer, the retailer can made the purchasing order to management system 30.

In addition, the product database 301 contains a plurality of user index including gender, age, and race, to generally statistically determine the distance of the pupils of the consumer. Accordingly, there are two different genders, i.e. male and female, to statistically classify the range of the pupil-distance so as refine the size of the frame. For the factor of age, the product database 301 contains three categories for classifying the sizes of the frame, i.e. senior, junior, and adult, to further refine the size of the frame. It is worth to mention that each category can be further broken down into several sub-categories such as teenage, and preteen. For the factor of race, Asian has a statistical range of the pupil-distance which is different from the statistical range of the pupil-distance for European. Therefore, by inputting the race, the network of the present invention is adapted to generate a statistical range of the pupil-distance for the corresponding race. As a result, by combining the factors of gender, age, and race, the network can statistically determine the range of the pupil-distance for the consumer.

Furthermore, detail information can also be input to make an advance determination, wherein the detail information contains the height and weight of the consumer, and the facial shape of the consumer. Accordingly, by inputting the gender, age, race, height and weight of the user, the corresponding size of the eyeglasses frame can be presumably filtered from the database. In particularly, having the facial shape of the consumer, such as round shape or oval shape, the distance between the two pupils of the consumer can be presumable calculated.

Accordingly, the height of the consumer is considered as one of the major factors to determine the distance between the pupils of the consumer because the increase of the pupil-distance is in proportion to the increase of the height of the consumer. Statistically speaking, the statistical data for the height has a range between 1 m to 2 m and the statistical data for the pupil-distance has a range between 40 mm to 200 mm with respect to the height. Therefore, by inputting the data of the height of the consumer, the product database is adapted to statistically determine the distance of the pupils of the consumer so as to minimize the error thereof to select the spectacle image.

It is worth to mention that all above mentioned information, including gender, age, race, height, weight, and the facial shape of the consumer, is basic information wherein all the consumers are able to provide such information. Having such information, the product database 301 is adapted to statistically determine the distance of the pupils of the user. The error of the statistical distance by the network would be less than 3 mm difference of the real distance of the pupils of the consumer. Accordingly, the product database 301 further contains a statistical distance database storing the statistical data of the distance of the pupils of the consumer regarding to the information of gender, age, race, height, weight, and the facial shape of the consumer. Of course, if the user is able to provide more information, the error of the statistical distance by the network will be further minimized.

Furthermore, the consumers are able to test-try the product through the sale stations 20, the management system 30 and the product provider stations 10 through the method mentioned above. Therefore, the present invention enlarges the network to link the retailers/exclusive venders and the wholesalers/manufacturers with the consumers.

The following illustrates that the consumer station 32 provides a test-wearing image system and producing method for a personal product to generate a photo realistic effect on a display to simulate a wearing image for the wearer.

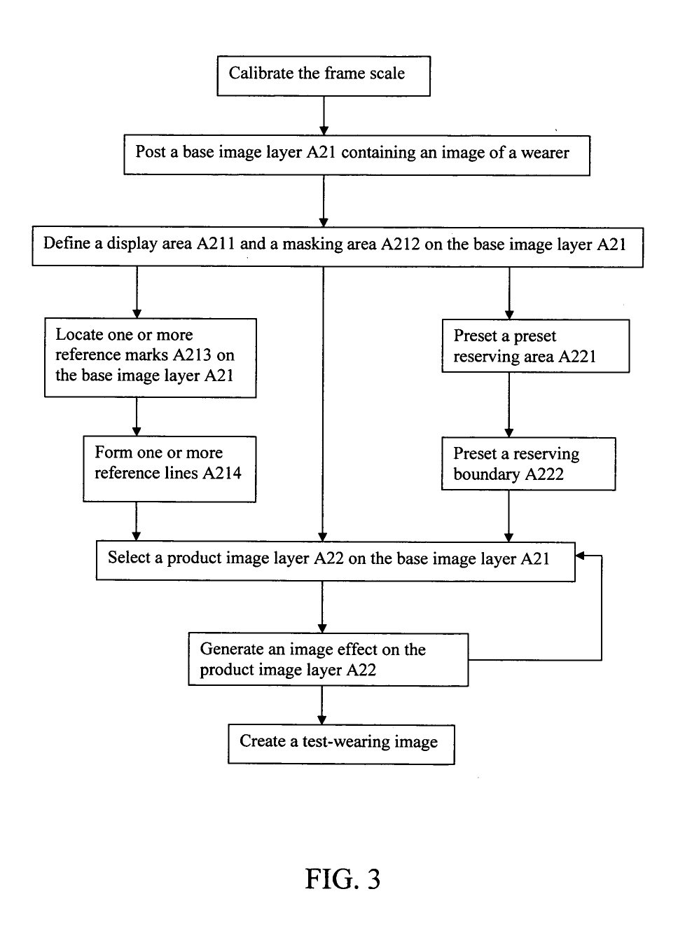

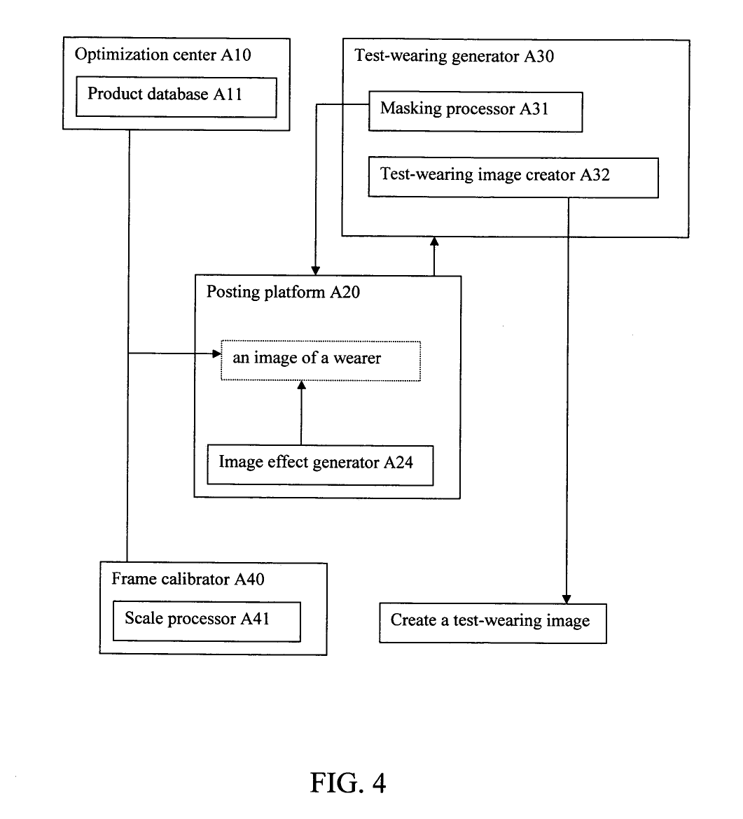

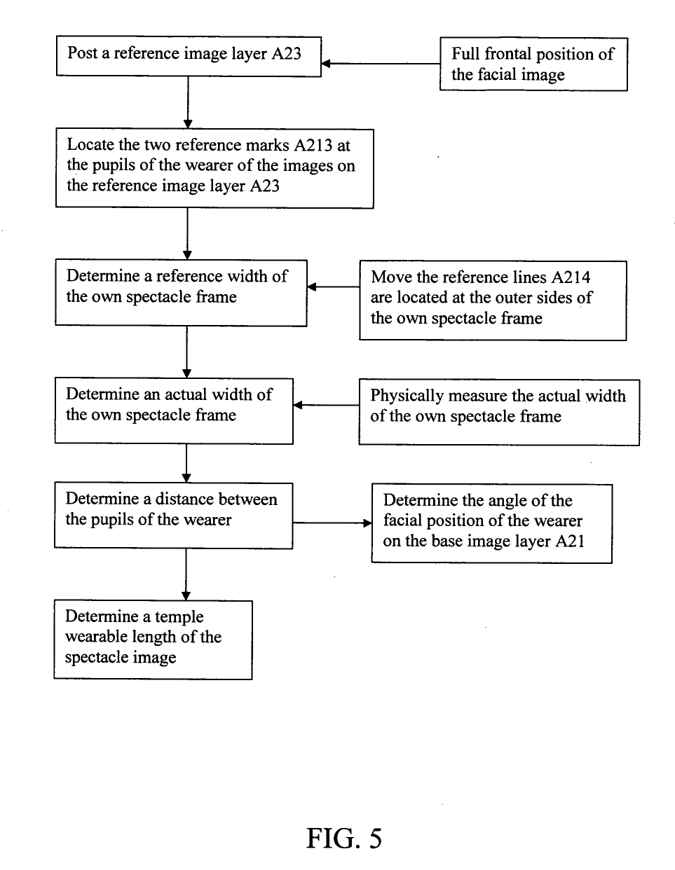

According to the preferred embodiment, the test-wearing image producing method, as shown in FIGS. 3 to 8B, comprises the following steps.

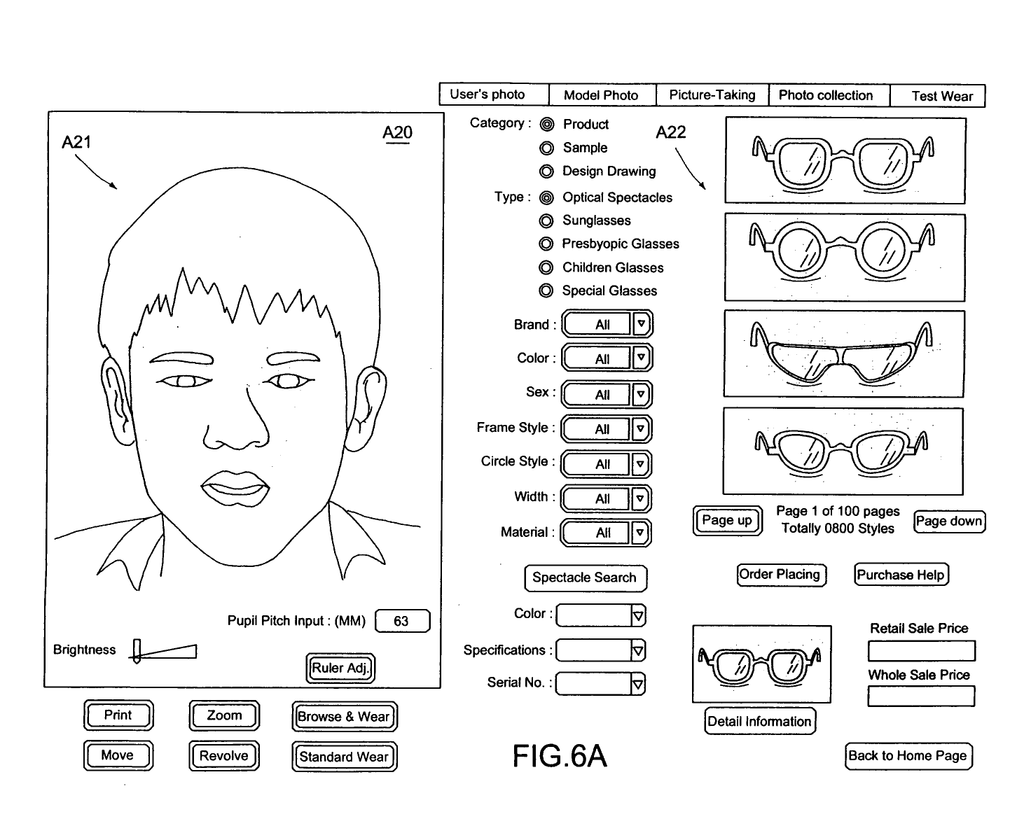

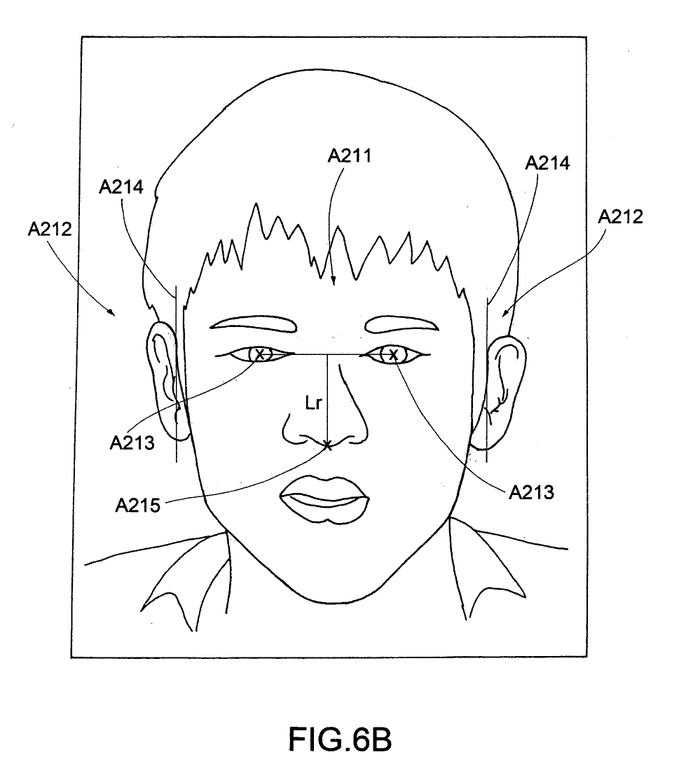

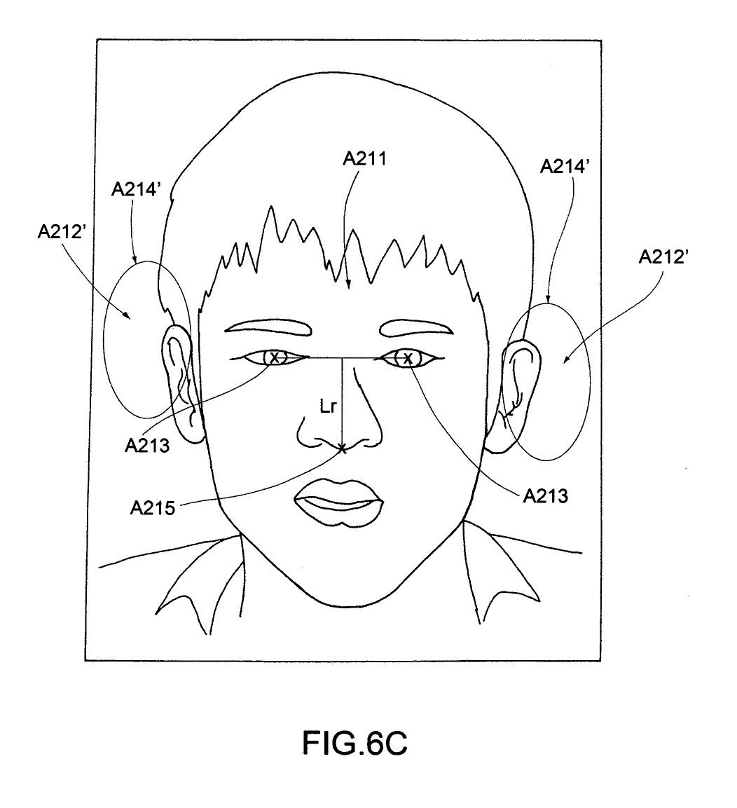

(1) Post a base image layer A21 which contains an image of a wearer, as shown in FIGS. 3 and 6A.

(2) Define a display area A211 on the base image layer A21 and a masking area A212 or A212′ on the base image layer A21 in responsive to the personal product being physically worn by the wearer, as shown in FIGS. 6B and 6C.

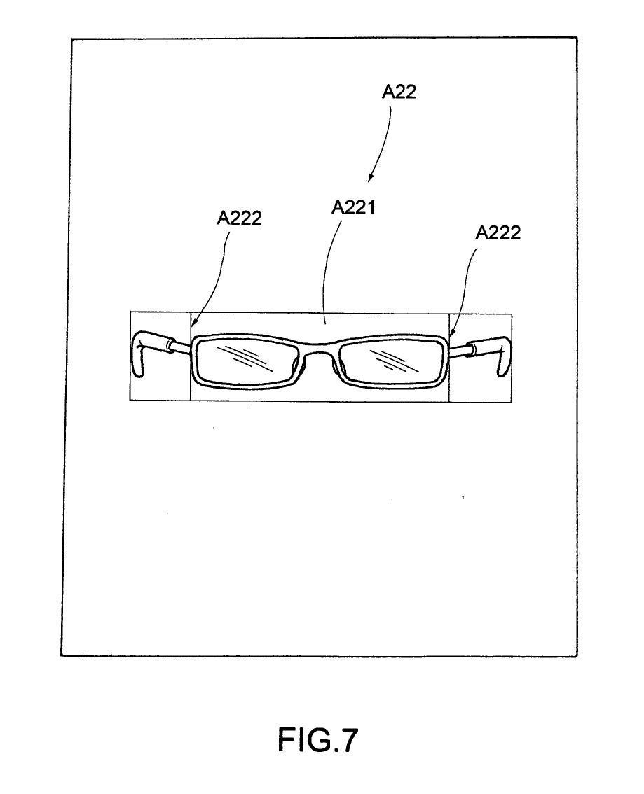

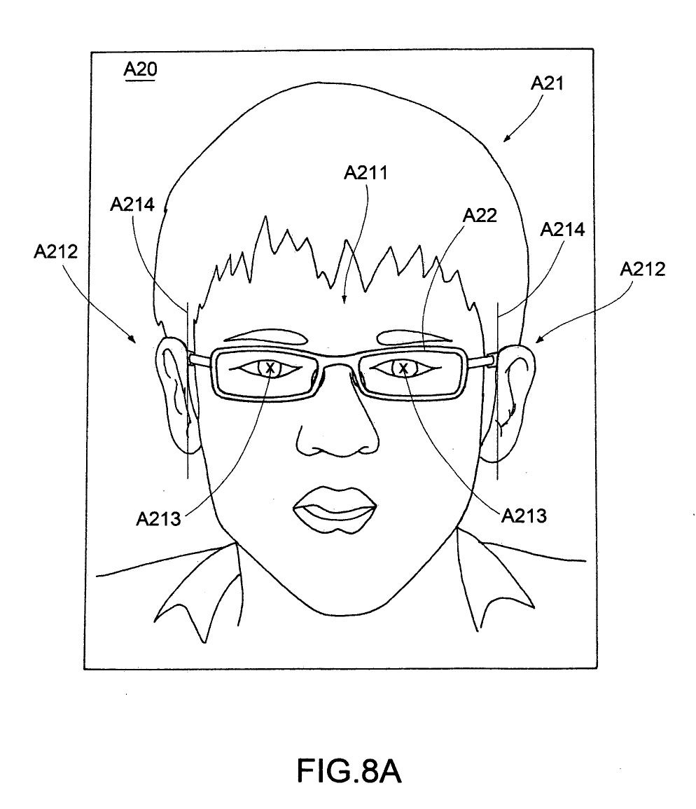

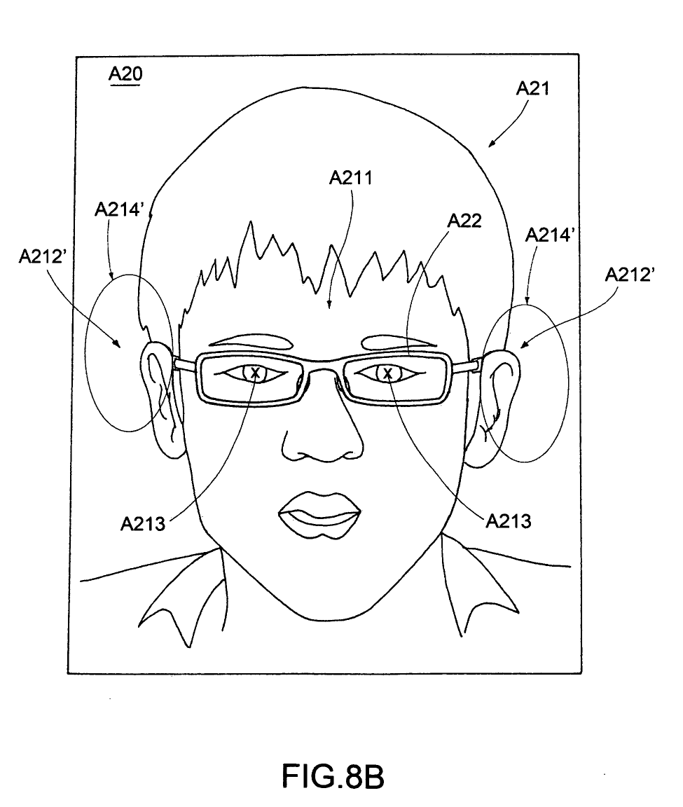

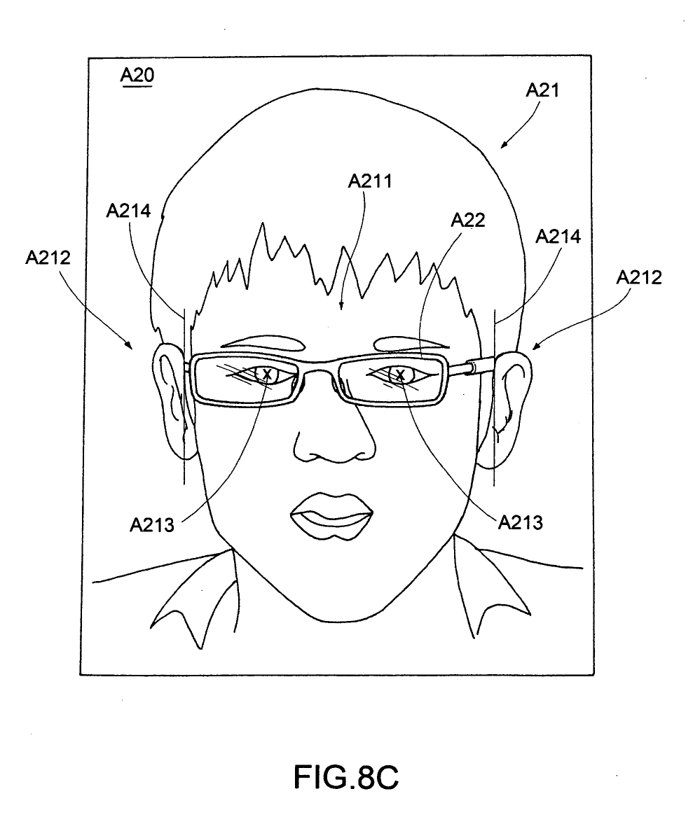

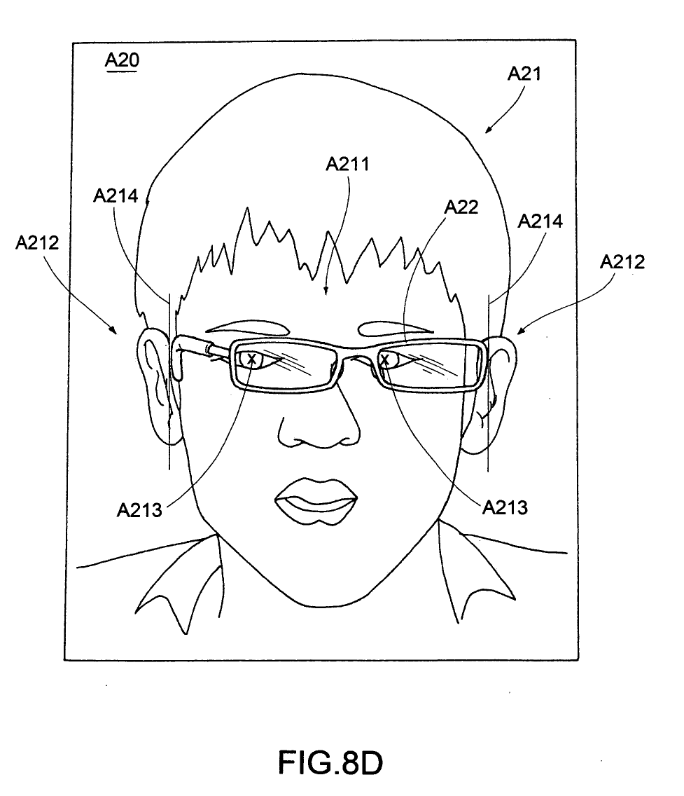

(3) Locate a selected product image layer A22 on the base image layer A21 in an adjustably movable manner, wherein the product image layer A22 contains an image of the personal product, as shown in FIGS. 7 to 8B.

(4) Create a test-wearing image when the product image layer A22 is overlapped on the base image layer A21, wherein a portion of the image of the personal product within the display area A211 is visibly shown on the image of the wearer while a portion of the image of the personal product within the masking area A212 or A212′ is invisibly hidden, such that the test-wearing image contains a virtual appearance of the wearer physically wearing the personal product, as shown in FIGS. 8A and 8B.

According to the preferred embodiment, the system comprises an optimization center A10, a posting platform A20, and a test-wearing generator A30.

The optimization center A10 has an image frame database A11, which is adapted for a wearer to access, containing a plurality of digital images of the personal products for the user to select. The optimization center A10 can be a software containing the system of the present invention for installing into the personal computer or can access the system of the present invention through a communication network such as Internet.

The posting platform A20, which is communicatively linked to the frame database A11, is arranged for the wearer posting the base image layer A21 and the product image layer A22 on the posting platform A20.

As shown in FIG. 6A, detail information can also be input to make an advance inquiry, wherein the detail information contains the height and weight of the user, and the facial shape of the wearer. Accordingly, by inputting the gender, age, race, height and weight of the wearer, the corresponding image size of the spectacle frame can be presumably filtered from the frame database A11. In particularly, having the facial shape of the wearer, such as round shape or oval shape, the distance between the two pupils of the user can be presumable calculated. It is worth to mention that the information of gender, age height, weight, and facial shape of the user can only used for test wearing purpose.

The test-wearing generator A30, which is communicatively linked to the posting platform A20, comprises a masking processor A31 defining the display area 211 and the masking area A212 or A212′ on the base image layer A21 in responsive to the personal product to be worn by the wearer, and a test-wearing image creator A32 creating the test-wearing image when the product image layer A22 is overlapped on the base image layer A21, as shown in FIGS. 8A and 8B. After the test-wearing image is created, the wearer can save the corresponding personal product selected by the wearer and the settings of the base image layer A21 and the product image layer A22.

According to the preferred embodiment, the personal product can be a watch, an ear ring, a necklace, and etc. that the personal product can be worn by the wearer. Preferably, the personal product is embodied as a spectacle frame to be worn by the wearer in which the spectacle frame requires a precise alignment for the wearer to wear. Accordingly, the following example illustrates the operation of the test-wearing system for the spectacle frame.

In the step (1), the wearer can access the optimization center A10 to post one or more photos of image of the wearer(s) on the posting platform A20, wherein the images of the wearers can be the images of the users or the image of the model wearers preloaded in the system. In other words, a user can post one or more his or her own photos on the posting platform A20 to simulate the test-wearing image of the user wearing the personal product or can select the photo of one of the model wearers on the posting platform A20 to simulate the test-wearing image of the model wearer wearing the personal product.

For the spectacle test-wearing example, the image of the wearer is facial image of the wearer and the image of the personal product is an image of the spectacle frame, such that the test-wearing image contains the virtual appearance of the wearer wearing the spectacle frame. Each image of the spectacle frames contains the image of the frame body including the two temples and the spectacle bridge, and preferably the lenses, as shown in FIG. 7.

After the base layer image A21 is shown on the posting platform A20, the display area A211 and the masking area A212 or A212′ must be defined on the base layer image A21 in the step (2). As shown in FIG. 6B, the display area A211 is set between two facial side peripherals of the facial image while the masking area A212 or A212′ is set at each of auricle areas of the facial image, such that when the product image layer A22 is overlapped on the base image layer A21, a corresponding portion of the image of the spectacle frame within the display area A211 is visibly shown between the facial side peripherals of the facial image while another portion of the image of the spectacle frame within the masking area A212 or A212′ is invisibly hidden to generate the test-wearing image containing the virtual appearance of the wearer wearing the spectacle frame.

Therefore, when the product image layer A22 is overlapped on the base image layer 21, the frame body of the spectacle frame is aligned within the display area A211 to overlap on the facial image of the wearer. In addition, the rear portions of the temples are aligned within the masking area A212 or A212′ such that the rear portions of the temples are invisibly hidden on the test-wearing image.

In the step (2), as shown in FIG. 6B, the method comprises a step of (2.1) locating one or more reference marks A213 on the base image layer A21 to define the display area A211 and the masking area A212 or A212′ in responsive to the reference marks A213, and locating two masking marks A214 at the facial side peripherals of the facial image respectively on the base image layer A21, wherein a distance between the two masking marks A214 is set to be larger than a distance between the two reference marks A213.

In particularly, two reference marks A213 are selectively located at two pupils of the wearer of the image thereof and the two masking marks A214 are preferred to be located at the conjunctions of the ears and the sideburns of the facial image respectively on the base image layer A21, where the tail portions of the temples will be hidden by the ears of the wearer from the front appearance.

Referring to FIG. 6B, the two masking marks A214 are embodied as two parallel lines set to locate at the two conjunctions of the ears and the sideburns of the facial image respectively, so that the display area A211 is set between the masking marks A214, i.e. between two facial side peripherals of the facial image and the masking area A212 is set an area out of each of the masking marks A214, i.e. each of auricle areas of the facial image.

Alternatively, as shown in FIG. 6C, the two masking marks A214′ are embodied as two oval shaped marks each encircling portion or the whole ear on each side of the facial image while the contour lines of the oval marks pass the two conjunctions of the ears and the sideburns of the facial image respectively. The masking area A212′ which is the area encircled by each of the oval shaped masking marks A214′ should large enough to cover the tail portion of the respective temple to be hidden by the respective ear. The masking area A212′ can be changed by changing the size of the oval masking mark A214′.

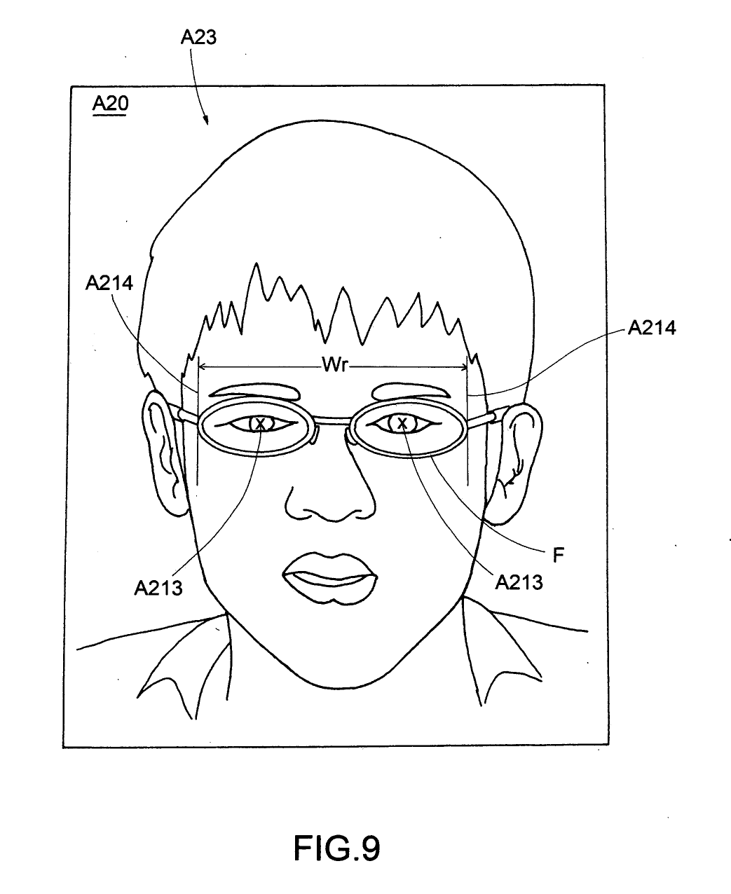

As it is mentioned above, the spectacle frame requires a precise alignment for the wearer to wear. In other words, the image of spectacle frame must be match with the facial image that the reference marks A213 of the spectacle frame must be aligned with the pupils of the wearers. As shown in FIG. 9, the method of the present invention, before the step (1), further comprises a pre-step of calibrating a frame scale of the spectacle image with respect to the facial image, wherein the calibrating step comprises the following steps.

(A) Post a reference image layer A23 which contains an image of the wearer wearing a personal product, such as an own spectacle frame, which the wearer can substantially measure a front width of two reference points of the personal product that is illustrated in the image of the wearer.

(B) Locate the two reference marks A213 at the pupils of the wearer of the images on the reference image layer A23.

(C) Determine a reference width Wr of the own spectacle frame F on the reference image layer A23 by an indication of the two reference points such as two outer sides of the own spectacle frame F.

(D) Determine an actual width of the personal product, i.e. the distance between the two reference points, such as the own spectacle frame F by actually measuring the actual width thereof by the wearer, such that by comparing the reference width Wr of the own spectacle frame F on the reference image layer A23 with the actual width of the own spectacle frame F, a distance between the pupils of the wearer is determined to match with the frame scale of the spectacle image with respect to the facial image of the wearer on the base image layer A21.

It is worth to mention that the calibrating step of the present invention is adapted to determine the distance between the pupils of the wearer through the system.

The system of the present invention further comprises a frame calibrator A40 for calibrating the frame scale of the spectacle image with respect to the facial image, wherein the frame calibrator A40 is communicatively linked to the posting platform A20 for posting the reference image layer A23 to locate the two reference marks A213 at the pupils of the wearer of the images on the reference image layer A23, wherein the frame calibrator A40 comprises a scale processor A41 not only comparing the reference width Wr of the own spectacle frame F on the reference image layer A23 with the actual width of the own spectacle frame F but also determining the distance between the pupils of the wearer to match with the frame scale of the spectacle image with respect to the facial image of the wearer on the base image layer A21.

In the step (A), the wearer is able to post his or her facial image, preferably a full frontal photo as the facial image, on the posting platform A20. Accordingly, when the full frontal photo of the wearer is posted on the posting platform A20, the facial image will shown two pupils of the wearer and the frontal photo of the own spectacle frame F on the full frontal photo of the wearer.

In the step (B), when the two reference marks A213 are located at the pupils of the wearer of the images on the reference image layer A23, the scale processor A41 will determine the distance between the two reference marks A213 to represent the distance of the pupils of the wearer.

In the step (C), the wearer is able to pin-point the two outer sides of the own spectacle frame on the reference image layer A23 to indicate the reference width Wr of the own spectacle frame F thereon the reference image layer A23, wherein the scale processor A41 will read the reference width Wr corresponding to the distance between the two reference marks A213. Accordingly, the two masking marks A214 or A214′ are selectively moved by the wearer until the masking marks A214 or A214′ are located at the outer sides of the own spectacle frame F on the reference image layer A23 to indicate the reference width Wr of the own spectacle frame F.

In the step (D), the wearer is able to physically measure the actual width of the own spectacle frame F by a measuring tool such as ruler. It is easily for the wearer to measure the actual width of the own spectacle frame F between the outer sides thereof in responsive to the outer sides of the own spectacle frame F on the reference image layer A23 being pin-pointed in the step (C). It is worth to mention that the wearer is able to measure the actual distance between the pupil marks of the own spectacle frame F in the step (D). However, it is hard and inaccurate for the wearer to determine the distance between the pupil marks of the own spectacle frame F comparing with the determination of the distance between the outer sides of the own spectacle frame F. Once the data of the actual width of the own spectacle frame F is input, the frame calibrator A40 will determine the actual distance between the pupils of the wearer and will match the frame scale of the spectacle image with respect to the facial image of the wearer on the base image layer A21.

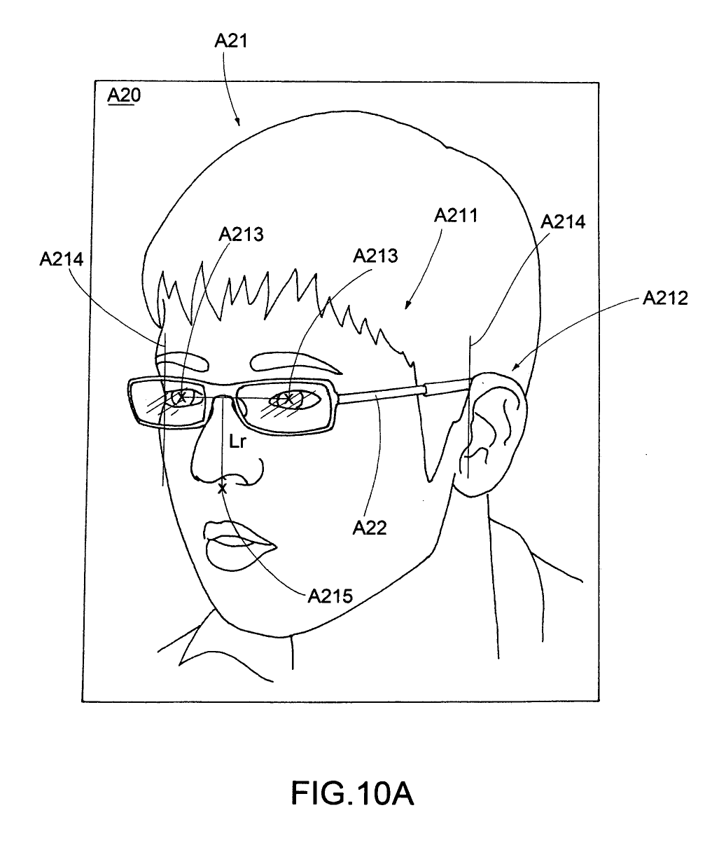

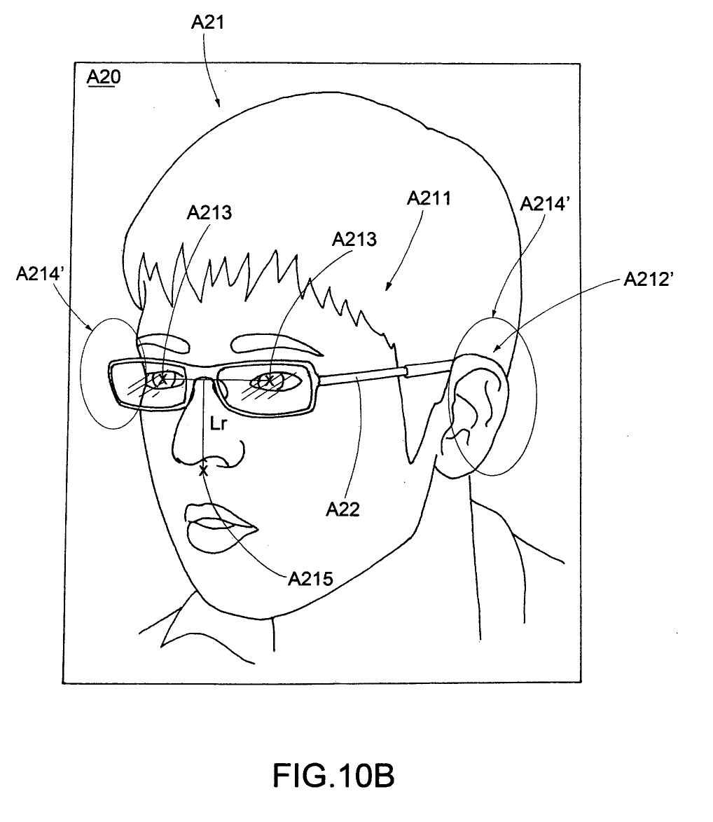

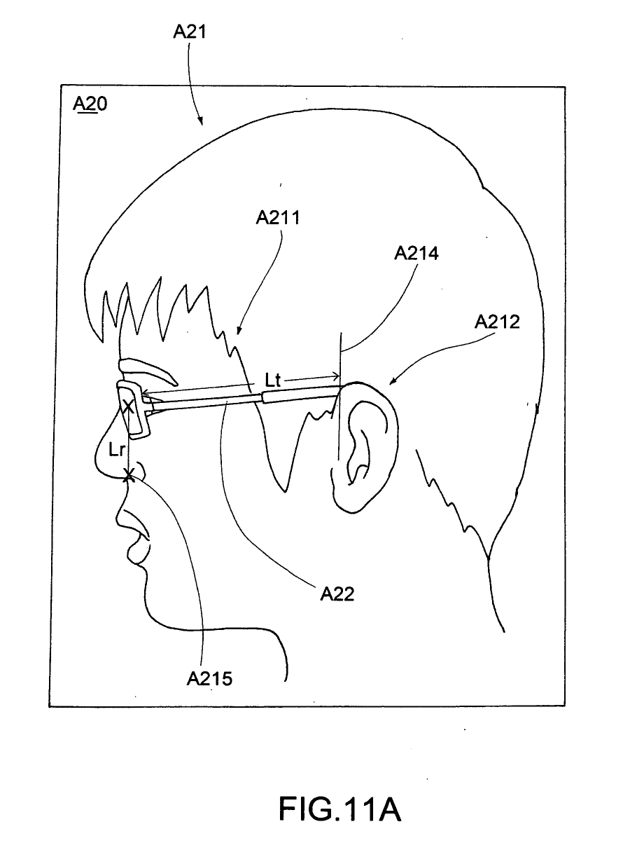

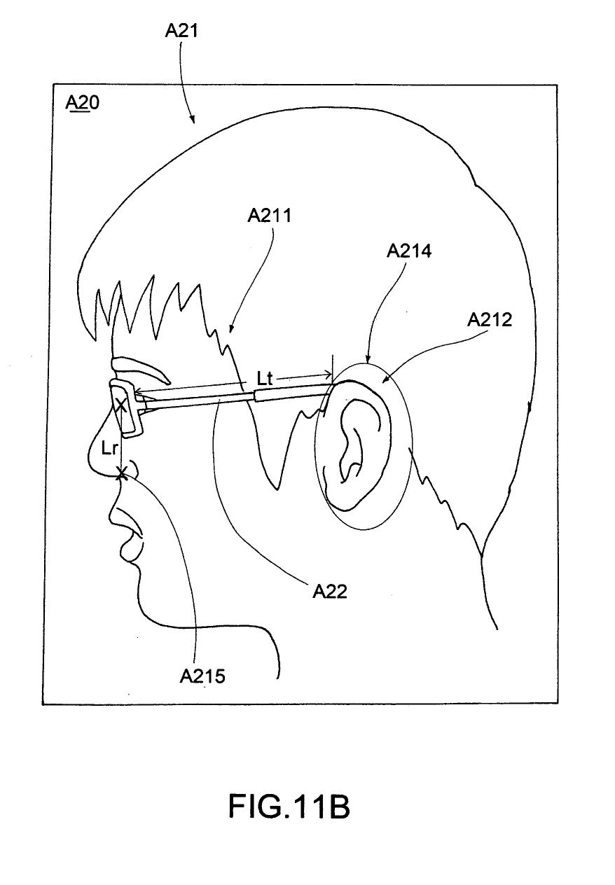

As it is mentioned above, the facial image is a full frontal photo posted on the posting platform A20. The wearer is able to post the facial image in different angles, such as a three quarter face position as shown in FIGS. 10A and 10B or side face position as shown in FIGS. 11A and 11B, for matching with different orientations of the images of the spectacle frame.

After the actual distance between the pupils of the wearer is defined, the system of the present invention will determine the angle of the facial position of the wearer on the base image layer A21.

Accordingly, the wearer is able to locate a third reference mark A215 at the base image layer A21 after the step (B) to determine a reference proportion of the facial image with respect to the distance between the pupils of the wearer. Preferably, as shown in FIGS. 6B and 6C the third reference mark A215 is pin-pointed at the tip of the nose on the full frontal photo of the wearer. Therefore, the frame calibrator A40 will determine the reference length Lr of the nose of the wearer with respect to the distance of the pupils of the wearer. When the facial image of the wearer is changed from the full frontal position to the three quarter face position or even the side face position, the frame calibrator A40 will keep the reference length Lr of the nose of the wearer as a reference data to selectively adjust the size of the facial image in responsive to the full frontal position of the facial image.

In particularly, the reference length Lr of the nose of the wearer on the base image layer A21 is set as a constant such that when the head of the wear on the base image layer A21 is rotated, the distance between the two reference marks A213 will be correspondingly changed. For example, the distance between the reference marks A213 is maximized on the base image layer A21 when the full frontal position of the facial image is provided thereon. When the position of the facial image is changed with respect to the rotational movement of the head of the wearer, as shown in FIGS. 10A to 11B, the system of the present invention will set the reference length Lr of the nose of the wearer as a constant and will determine the distance between the reference marks A213. By determining the ratio between the reference length Lr of the nose of the wearer and the changed distance between the reference marks A213, the angle of the head of the wearer on the base image layer A21 can be measured. When the position of the facial image is changed to the side face position, as shown in FIGS. 11A and 11B, the reference marks A213 are overlapped to form a single mark. Therefore, the system will determine the position of the facial image is changed 90° from the full frontal position to the side face position.

Therefore, the images of the spectacle frames with the corresponding orientations will match with the angles of the facial image to overlap the product image layer A22A on the base image layer A21. For example, the image of the spectacle frame with the three quarter face position will match with the facial image of the wearer with the three quarter face position.

It is worth to mention that the wearer is able to post a video clip of the facial image on the posting platform A20 to show the 360° rotational position of the face position, such that the images of the spectacle frame will match with the facial image of the video clip to illustrate a 360° rotational orientation of the facial image of the wearer wearing the corresponding spectacle frame.

Furthermore, the system further defines a temple wearable length Lt of the spectacle image on the product image layer A22 in responsive to an actual temple wearable length of the spectacle frame. When the side facial position of the wearer is posted on the base image layer A21, as shown in FIGS. 11A and 11B, the display area A211 is defined between the frame body and the auricle areas of the facial image while the masking area A212 or A212′ is defined at the auricle areas of the facial image. Accordingly, the dimension of the facial image on the base image layer A21 is set proportionally. Once the actual distance between the pupils of the wearer is defined, other dimensions of the spectacle frame can be proportionally determined. When the distance between the pupils of the wearer is found, the reference length Lr of the nose of the wearer is correspondingly determined. By using the reference length Lr of the nose of the wearer, the temple wearable length Lt of the spectacle image will be determined.

Accordingly, the temple wearable length Lt of the spectacle image is the distance between the reference mark A213 (located at the pupil of the wearer on the base image layer A21) and the masking mark A214 or A214′ (located at the auricle areas of the facial image). It is worth to mention that when the wearer physically wears the spectacle frame, a straight portion of the temple is visibly located at the face of the wearer while the curving tail portion of the temple is invisibly passed over the ear of the wearer. In other words, the spectacles must be defined at a point on the temple to be bent to form the straight portion and the tail portion. Accordingly, the temple wearable length of the temple is the straight portion of the temple.

According to the preferred embodiment, after the reference marks A213 are located on the base image layer A21 to define the display area A211 and the masking area A212 or A212′ in the step (2.1), the step (2) further comprises a step (2.2) of selectively adjusting the masking marks A214 or A214′ at the facial side peripherals of the facial image respectively on the base image layer A21 to precisely define the display area A211 between the two masking marks A214 or A214′ and the masking area A212 or A212′ out of each of the masking marks A214 or A214′.

When the wearer selects the image of the model wearer to be posted on the posting platform A20 in the step (3), the display area A211 and the masking area A212 or A212′ are preset on the base image layer A21. In other words, the wearer is not required to adjust the masking marks A214 or A214′. However, when the wearer posts his or her image on the posting platform A20, he or she may need to fine tune the display area A211 and the masking area A212, A212′ to fit the shape of the face of the wearer. Accordingly, when the wearer locates the reference marks A213 at two pupils of the wearer of the image thereof, the masking marks A214, A214′ are automatically formed. The user is able to adjust the position of each of the masking marks A214, A214′ until the masking mark A214, A214′ is moved to align with the corresponding facial peripheral of the facial image. It is worth to mention that when the wearer has a long hair that the hair covers the facial peripheral of the facial image, the wearer is able to move the masking mark A214, A214′ to the peripheral of the hair in which the portion of the spectacle frame is also covered by the hair in a hidden manner.

It is worth to mention that the distance between the two masking marks A214, A214′ is set to be larger than the distance between the two reference marks A213. Therefore, the wearer is restricted to move each of the masking mark A214, A214′ between the two reference marks A213. In other words, each of the reference marks A213 must be located between the two masking marks A214, A214′.

Once the base image layer A21 is set, the wearer is able to select the desired image of the spectacle frame in the product database A11. Then, the selected image of the spectacle frame, as shown in FIG. 7, is posted on the posting platform A20 as the product image layer A21. It is worth to mention that the product image layer A21 is automatically aligned with the base image layer A21. In particularly, the pupil marks of the spectacle frame on the product image layer A22 are aligned with the pupils of the wearer on the base image layer A21.

As shown in FIGS. 8A and 8B, the frame body of the spectacle frame on the product image layer A22 is located within the display area A211 of the base image layer A21. Front portions of the temples of the spectacle frame on the product image layer A22 are also located within the display area A211 of the base image layer A21. However, the two tail portions of the temples of the spectacle frame on the product image layer A22 are located within the masking areas A212, A212′ of the base image layer A21. Therefore, the frame body and the front portions of the temples of the spectacle frame will be visibly displayed on the base image layer A21 while the tail portions of the temples of the spectacle frame will be invisibly hidden on the base image layer A21.

It is appreciated that the product image layer A22 can be selectively moved to overlap at a desired location of the base image layer A21. Accordingly, the wearer is able to drag the product image layer A22 to move while the base image layer A21 is fixed on the posting platform A20 so as to selectively move the image of the spectacle frame on the facial image of the wearer. Therefore, the wearer can adjust the location of the product image layer A22 with respect to the base image layer A21. For example, some wearers would like to physically wear the own spectacle frame at a position that the pupil marks of the spectacle frame are slightly offset with the pupils of the wearer.

Accordingly, when the product image layer A22 is moved, a portion of the frame body of the spectacle frame on the product image layer A22 may be located within the masking area A212, A212′ of the base image layer A21. Therefore, the portion of the frame body will be invisibly hidden.

As shown in FIG. 8C, the product image layer A22 is moved to the left side on the base image layer A21. The frame body of the spectacle frame on the product image layer A22 is moved closer to the left masking area A212, A212′ while the frame body of the spectacle frame on the product image layer A22 is moved away from the right masking area A212, A212′. Therefore, the tail portion of the left temple on the product image layer A22 becomes shorter while the tail portion of the right temple on the product image layer A22 becomes longer.

In order to prevent the diminution the frame body of the spectacle frame on the product image layer A22, the product image layer A22 contains a preset reserving area A221 at the image of the personal product that the reserving area A221 is visibly shown within both the display area A211 and the masking area A212, A212′, as shown in FIG. 7. Preferably, the reserving area A221 is preset on the product image layer A22.

In this spectacle frame example, the reserving area A221 is preset at the area of the image of the frame body of the spectacle frame. In other words, the image of the frame body will not be hidden within the masking area A212, A212′.

For better operation, the masking area A212, A212′ of the base image layer A21 is adjustably changed in responsive to the movement of the product image layer A22. In particularly, the sizes of the display area A211 and the masking area A212, A212′ of the base image layer A21 are correspondingly adjusted in responsive to the reserving area A221.

When the reserving area A221 is moved to the masking area A212, A212′ from the display area A211, the size of the masking area A212, A212′ is reduced while the display area A211 is enlarged, such that the reserving area A211 of the image of the personal product is always visibly shown on the base image layer A21. Likewise, when the reserving area A221 is moved back from the masking area A212, A212′ to the display area A211, the display area A211 will be reduced back to its original size. In other words, once the display area A211 is set in the step (2), the minimum size of the display area A211 is set. The wearer is able to adjust the display area A211 in the step (2).

In order to adjust the size of the display area A211, the reserving area A221 of the image of the personal product defines an outer reserving boundary A222 arranged in such a manner that when the reserving area A221 is moved until the reserving boundary A222 meets one of the masking marks A214, the corresponding masking mark A214 is moved to adjust the size of the display area A211.

As shown in FIG. 8D, the product image layer A22 is moved to the right side on the base image layer A21. The right outer reserving boundary A222, i.e. the frame body of the spectacle frame on the product image layer A22, is moved to meet the right masking area A212, A212′ while the left right outer reserving boundary A222 is moved away from the left masking area A212, A212′. Therefore, the tail portion of the left temple on the product image layer A22 becomes longer while the right temple on the product image layer A22 is hidden. In addition, the right masking area A212, A212′ is moved to the right side in responsive to the right outer reserving boundary A222.

Back to the spectacle example, the reserving boundary A222 is defined at each outer border of the reserving area A221 which is the outer side of the frame body, as shown in FIG. 7. When the image of the spectacle frame on the product image layer A22 is moved, i.e. moving left or right on the base image layer A21, the reserving boundary A222 may meet one of the masking marks A214. In particularly, when the outer side of the frame body meets the respective masking mark A214, the masking mark A214 will be moved corresponding to the outer side of the frame body. For example, when the wearer moves the product image layer A22 to the right direction, the right outer side of the frame body, i.e. the right reserving boundary A222 of the reserving area A221, will meet the right masking mark A214, A214′. Once the wearer keeps moving the product image layer A22 to the right direction, the right masking mark A214, A214′ will be correspondingly moved to the right direction followed by the right reserving boundary A222. Therefore, the display area A211 defining between the left and right masking marks A214, A214′ will be enlarged while the right masking area A212, A212′ will be reduced. Once the wearer moves back the product image layer A22 to the left direction, the right masking mark A214, A214′ will be correspondingly moved to the left direction followed by the right reserving boundary A222. Accordingly, the right masking mark A214, A214′ will be stopped moving to the left direction when the right masking mark A214, A214′ is returned back to its original position. In other words, the right masking mark A214, A214′ will only be moved back to its original position even though the product image layer A22 is kept moving to the left direction. In addition, the display area A211 can be adjusted by the moving the masking mark A214, A214′ in the step (2).

The product image layer A22 further contains an image effect generator A24 to enhance the test-wearing image of the virtual appearance of the wearer physically wearing the personal product. According to the preferred embodiment, the product image layer A22 further contains a fade out effect to gradually diminish the image of the personal product from the display area A211 to the masking area A212, A212′ of the base image layer A21 for enhancing the test-wearing image of the virtual appearance of the wearer actually wearing the personal product.

Accordingly, the fade out effect is applied at the front portion of each of the temples of the spectacle frame on the product image layer A22 because the front portion of each of the temples is extended from the display area A211 to the masking area A212, A212′. Therefore, the front portion of each of the temples is gradually faded out on the product image layer A22 until the rear portion of each of the temples is invisibly diminished.

The product image layer A22 further contains a light reflective effect provided within the reserving area A221 to generate a light reflection of the image of the personal product for enhancing the test-wearing image of the virtual appearance of the wearer actually wearing the personal product. In particularly, the light reflective effect is applied at each of the lenses of the spectacle frame on the product image layer A22. It is worth to mention that when the frame body of the spectacle frame is made of metal, the frame body may also reflect the light. Therefore, the light reflective effect can also applied at the frame body of the spectacle frame on the product image layer A22 to enhance the photo realistic effect of the test-wearing image.

The product image layer A22 further contains a shading effect provided at the image of the personal product to simulate a shading of the personal product on the image of the wearer. Accordingly, when light is projected on the spectacle frame, the shading of the spectacle frame may be projected on the face of the wearer. Therefore, when the product image layer A22 is overlapped on the base image layer A21, the shading effect will be applied on the image of the spectacle frame to the facial image of the wearer.

The product image layer A22 further contains a color blending effect provided at the image of the personal product to blend a color of the image of the personal product with a color of the image of the wearer. In particularly, when the frame body is made of transparent material, the skin color of the wearer may show on the frame body. In this spectacle example, the nose supports of the spectacle frame are made of transparent material. Therefore, the color blending effect is applied at each of the nose supports of the spectacle frame on the product image layer A22 to show the skin color of the facial image on the base image layer A21.

According to the preferred embodiment, the wearer is able to select different product image layers A22 to overlap on the base image layer A21 in the step (3), wherein the system of the present invention will save the setting including the display area A211 and the masking area A212, A212′ on the base image layer A21 in the step (2) unless the wearer changes the setting thereof. In addition, more than one product image layers A22 can be selected to overlap on the base image layer A21. In the spectacle example, the wearer is allowed to select one product image layer A22 to overlap on the base image layer A21 at one time because the wearer can only wear one spectacle frame at one time. For selecting the jewelries, two or more product image layers A22, such as ear ring and necklace, can be selected at the same time to overlap on the base image layer A21 at different locations thereof.

The following example illustrates the operation of the wearer test-wearing the watch to create the test-wearing image contains a virtual appearance of the wearer physically wearing the watch.

Accordingly, the wearer is able to post his or her image on the posting platform A20 in the step (1), wherein the image of the wearer contains a frontal wrist image thereof where the watch is worn. Likewise, the wearer is able to select the image of the model wearer on the posting platform A20.

Then, the wearer is able to define the display area A211 and the masking area A212 on the base image layer A21 in the step (2). Firstly, the wearer is able to locate one reference mark A213 on the base image layer A21 at a center of the frontal wrist image thereof.

If the masking mark A214 is a masking line, two masking marks A214 are automatically formed at the side peripherals of the wrist image respectively on the base image layer A21. The wearer is able to selectively adjust each of the masking marks A214 to fittingly align at the respective side peripheral of the wrist image. Therefore, the display area A211 is then defined between the two masking marks A214 and the masking area A212 is then defined at an area out of the masking marks A214.

If the masking mark A214′ is an oval shaped masking mark A214′, the oval masking mark A214′ is automatically formed with two sides thereof located at the side peripherals of the wrist image respectively on the base image layer A21. The wearer is able to selectively adjust the size of the masking mark A214′ to fittingly align at the right and left side peripherals of the wrist image. Therefore, the display area A211 is then defined as the area within the masking mark A214′ and the masking area A212′ is then defined at the area out of the masking mark A214′.

In the step (3), the wearer is able to select the image of the watch as the product image layer A22 to be posted on the posting platform A20. Accordingly, the image of the watch contains a watch body portion and strap portion. Once the image of the watch is selected, the system of the present invention will automatically align the center of the watch body portion to the reference mark A213 on the base image layer A21. The wearer is able to adjustably move and rotate the image of the watch until the image of the watch body portion on the product image layer A22 is fittingly overlapped on the image of the wrist of the wearer on the base image layer A21. Therefore, the image of the watch body portion and parts of the strap are located within the display area A211 to be visibly displayed on the base image layer A21 while the image of portions of the strap will be located within the masking area A212, A212′ such that the portions of the strap will be invisibly hidden.

At the same time, the reserving area A221 and the reserving boundary A222 are also preset when the display area A211 is set. The reserving area A221 is set at the image of the watch body portion while the reserving boundary A222 is set at the boundary of the image of the watch body portion.

It is worth mentioning that the wearer is able to locate two reference marks at the side peripherals of the wrist image respectively on the reference image layer A23 or the base image layer. Therefore, the wearer is able to measure the actual width of the wrist of the wearer and input the actual width thereof to the system, wherein the frame calibrator A40 will calibrate the frame scale of the watch image with respect to the image of the wrist.

The product image layer A22 further applies the fade out effect at the image of the watch to gradually diminish the image of the strap of the watch extended from the display area A211 to the masking area A212. The light reflective effect is applied at the image of the watch body portion and/or the strap, especially at the lens of the watch body portion. The shading effect is taken place on the base image layer A21 at image of the wrist where the image of the watch is located. The color blending effect may be applied when the strap of the watch is made of transparent material.

Another example illustrates the operation of the wearer test-wearing the necklace to create the test-wearing image contains a virtual appearance of the wearer physically wearing the necklace.

Accordingly, the wearer is able to post his or her image on the posting platform A20 in the step (1), wherein the image of the wearer contains a frontal collar image thereof where the necklace is worn around the neck of the wearer. Likewise, the wearer is able to select the image of the model wearer on the posting platform A20.

Then, the wearer is able to define the display area A211 and the masking area A212, A212′ on the base image layer A21 in the step (2). Firstly, the wearer is able to locate one reference mark A213 on the base image layer A21 at a pendant point of the frontal collar image thereof. Then, one or more masking marks A214, A214′ are automatically formed at the neck peripherals of the collar image respectively on the base image layer A21. The wearer is able to selectively adjust each of the masking marks A214, A214′ to fittingly align at the respective neck peripheral of the collar image. Therefore, if the masking marks A214 are two masking lines, the display area A211 is then defined between the two masking marks A214 and the masking area A212 is then defined at an area out of the masking marks A214. If the masking mark A214′ is an oval shaped masking mark having two sides located at the neck peripherals of the collar image respectively on the base image layer A21, the display area A211 is defined as the encircled area within the oval masking mark A214′ and the masking area A212′ is then defined at the area outside the masking mark A214′.

In the step (3), the wearer is able to select the image of the necklace as the product image layer A22 to be posted on the posting platform A20. Accordingly, the image of the necklace contains a necklace body and a pendant. Once the image of the necklace is selected, the system of the present invention will automatically align the pendant of the necklace to the reference mark A213 on the base image layer A21. The wearer is able to adjustably move and rotate the image of the necklace until the image of the necklace body on the product image layer A22 is fittingly overlapped on the image of the collar of the wearer on the base image layer A21. Therefore, the image of the pendant and parts of the necklace body are located within the display area A211 to be visibly displayed on the base image layer A21 while the image of portions of the necklace body will be located within the masking area A212 such that the portions of the necklace body will be invisibly hidden.

At the same time, the reserving area A221 and the reserving boundary A222 are also preset when the display area A211 is set. The reserving area A221 is set at the image of the pendant while the reserving boundary A222 is set at the boundary of the image of the necklace body.

Accordingly, the system using “Macromedia Flash-Mask technique” is preferred to create the display area A211 and the masking area A212, A212′ on the base image layer A21. Other techniques, which can create the above mentioned features, can be used as well. The main advantage of the present invention is that the system thereof will only require two different layers, i.e. the base image layer A21 and the product image layer A22, such that the system will save lots of memory space.

As shown in FIG. 1, the consumer station 32 further comprises a consumer designing center 322 for the consumer self-designing the optical product, wherein the consumer designing center 322 is linked to the product provider stations 10 via Internet to tailor-made the optical product for the consumers. Accordingly, some consumers will have great ideas and designs for the optical products to fulfill the actual needs of the consumers. The consumer designing center 322 provides a creative channel to link the wholesalers and/or the manufacturers with the consumers for the consumers to design their optical products. Likewise, having the survey of the consumer's designing optical product, the manufacturers will manufacture the optical product and/or the wholesalers will request the manufacturer to manufacture the optical product. In other words, the consumer's creation will become a real optical product once the rating of the survey is high, which means lots of consumers like the design. Therefore, the present invention provides an interaction network among the retailers, the manufacturers, the wholesalers, and the consumers.

The consumer station 32 further comprises a consumer journal 323 for the consumer to provide personal commentary or new. The consumer is able to post the consumer's designing optical product in his or her consumer journal 323. Accordingly, the consumer journal 323, as a personal Blog, is considered as an on-going diary or commentary to form a communication channel for communicating with other consumers or other people as the readers, including retailers, venders, wholesalers, and manufacturers. The consumer is able to put the personal feedback or comment on the particular optical product that he or she has test-tried try and/or the image of the consumer test-wearing the optical product. In other words, the consumer journal 323 becomes a way to reflect on life he or she uses the present invention.

The readers are able to give the feedback to the consumer journal 323 that they like or dislike the corresponding optical product worn by the consumer. Modification of the optical product is appreciated to place in the consumer journal 323 as a recommendation to modify the optical product picked by the consumer.

As it is mentioned above, the order manager 31 is adapted to accumulatively consolidate the purchasing orders from the sale stations 20. The order manager 31 further provides a preliminary order from each of the product provider stations 10. Accordingly, the product provider is adapted to set the preliminary order in the product provider station 10 for a particular optical product, preferably by quantity, in order to complete the purchasing order. For example, the product provider is adapted to set the preliminary order for the optical product by ordering at least 1000 pairs of spectacle frame. Once the request from the sale stations 20 reaches the minimum numbers of the spectacle frame in the preliminary order, the wholesaler as the product provider will offer the corresponding optical product for sale at the sale stations 20. Likewise, the manufacturer, as the product provider, will start manufacture the corresponding optical product.

It is worth to mention that each of the consumers is able to put one or more requests in the preliminary order while each of the retailers is able to 100 requests in the preliminary order. All the requests will be accumulated from the sale stations 20 in order to meet the requirement of the preliminary order. If the newly designed optical product is picked for manufacture and sale, commissions would be given to the consumer who designs the optical product, so as to enhance the creativity of the optical product for the consumers.

According to the preferred embodiment, the management system 30 further comprises a delivering center delivering the optical product to the respective sale station 20 in responsive to the purchasing order. The delivering center of the management system 30 provides a purchasing record for each of the sale stations 20 and the product provider stations 10 once the optical product is delivered thereto. The purchasing record includes the information of the purchasing order which includes the price and the quantity of the optical product, and the shipment information which includes the delivering date and the receiving date of the optical product. Therefore, the retailers and the wholesalers can simplify the order management therebetween.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An optical product network, comprising:
a plurality of product provider stations for a plurality of wholesalers jointing therewith;
a plurality of sale stations for a plurality of retailers joining therewith; and
a management system forming a network bridge to link said product provider stations with said sale stations via Internet, wherein said management system manages a purchasing order from each of said sale stations for requesting an optical product from at least one of said wholesalers in a quantity manner, such that said management system is adapted for effectively managing said optical products to maximize a mutual benefit and collaboration between said wholesalers and said retailers in a quality and quantity manner.

2. The optical product network, as recited in claim 1, wherein each of said product provider station further comprises a plurality of exclusive venders for exclusively linking with said respective wholesaler to vend said optical products therefrom.

3. The optical product network, as recited in claim 1, wherein said management system further comprises a consumer station for consumers communicatively accessing thereto via Internet, wherein said consumer station provides a trial platform for said consumer virtually trying said optical products through Internet, such that said management system collets a database of consumers' favors for said retailers to make said purchase order thereof.

4. The optical product network, as recited in claim 3, wherein said consumer station comprises a facial capturing device which is provided at each of said sale stations for said retailer capturing a facial image of said consumer and is linked to said trial platform via Internet for simulating a virtual appearance of said consumer with said optical product.

5. The optical product network, as recited in claim 3, wherein said consumer station further comprises a consumer designing center for said consumer self-designing said optical product, wherein said consumer designing center is linked to said product provider stations via Internet to tailor-made said optical product for said consumers.

6. The optical product network, as recited in claim 3, wherein said consumer station further comprises a survey regarding interests and needs in different optical products for each of said consumers for said retailers analyzing to make said purchasing order.

7. The optical product network, as recited in claim 3, wherein said consumer station further comprises a new product forum for posting a new optical product thereon to let the consumers test-trying.

8. The optical product network, as recited in claim 1, wherein said management system comprises an order manager linking said product provider stations with said sale stations via Internet, wherein when said purchasing orders from said sale stations are accumulated by said order manager and are reached a predetermined quantity, said order manager simultaneously sends an ordering indication to said respective product provider station for contacting said corresponding wholesaler.

9. The optical product network, as recited in claim 1, wherein said management system further comprises a delivering center delivering said optical product to said respective sale station in responsive to said purchasing order, wherein said delivering center provides a purchasing record for each of said sale stations and said product provider stations once said optical product is delivered thereto.

10. The optical product network, as recited in claim 1, wherein said management system further comprises an update informer frequently updating a price of each of said optical products from said wholesalers to said retailers.

11. A method of networking an optical product between wholesalers and retailers, comprising the steps of:
(a) providing a plurality of product provider stations for said wholesalers jointing therewith;
(b) providing a plurality of sale stations for said retailers joining therewith;
(c) providing a management system as a network bridge to link said product provider stations with said sale stations via Internet;
(d) managing a purchasing order from each of said sale stations for requesting said optical product from at least one of said wholesalers in a quantity manner; and
(e) delivering said optical product to said respective sale station in responsive to said purchasing order, such that said management system is adapted for effectively managing said optical product to maximize a mutual benefit and collaboration between said wholesalers and said retailers in a quality and quantity manner.

12. The method, as recited in claim 11, wherein the step (b) further comprising the steps of:
(b.1) providing a plurality of exclusive venders under each of said product provider station; and
(b.2) exclusively linking said exclusive vender with said corresponding wholesaler to vend said optical products from said exclusive vender.

13. The method, as recited in claim 11, after the step (d), further comprising a step of providing a purchasing record for each of said sale stations and said product provider stations.

14. The method, as recited in claim 11, wherein the step (c) further comprising the steps of:
(c.1) providing a consumer station for consumers communicatively accessing thereto via Internet;
(c.2) providing a trial platform for said consumer trying said optical products through Internet; and
(c.3) collecting a database of consumers' favors for said retailers to make said purchase order thereof.

15. The method, as recited in claim 14, wherein the step (c.2) further comprises the steps of:
(c.2.1) providing a facial capturing device at each of said sale station for said retailer capturing a facial image of said consumer; and
(c.2.2) linking said facial capturing device with said trial platform via Internet for simulating a virtual appearance of said consumer with said optical product.

16. The method, as recited in claim 14, wherein the step (c) further comprises a step of providing a consumer designing center for said consumer self-designing said optical product, wherein said consumer designing center is linked to said product provider stations via Internet to tailor-made said optical product for said consumers.

17. The method, as recited in claim 14, wherein the step (c) further comprise the steps of:
providing a survey regarding interests and needs in different optical products for each of said consumers; and
saving said survey for said retailers to analyze to make said purchasing order.

18. The method, as recited in claim 14, wherein the step (c) further comprise a step of providing a new product forum for posting a new optical product thereon to let said consumers test-trying.

19. The method, as recited in claim 11, wherein the step (d) further comprises the steps of:
(d.1) providing an order manager linking said product provider stations with said sale stations via Internet;
(d.2) accumulating said purchasing orders from said sale stations by said order manager; and
(d.3) when said purchasing orders reach a predetermined quantity, simultaneously sending an ordering indication from said order manager to said respective product provider station for contacting said corresponding wholesaler.

20. The method, as recited in claim 11, further comprising a step of frequently updating a price of each of said optical products from said wholesalers to said retailers.
